(19) United States
(12) Patent Application Publication
(10) Pub. No.: US 2025/0326886 A1
(43) Pub. Date: Oct. 23, 2025

(54) POLYMER COMPOSITION, EPOXY RESIN COMPOSITION, CURING AGENT FOR EPOXY RESIN, AND FAST CURING ADHESIVE

(71) Applicant: Toray Fine Chemicals Co., Ltd., Tokyo (JP)

(72) Inventors: Tomoaki Nishimura, Ichihara-shi, Chiba (JP); Hiromitsu Abe, Ichihara-shi, Chiba (JP); Motoharu Seo, Ichihara-shi, Chiba (JP)

(73) Assignee: Toray Fine Chemicals Co., Ltd., Tokyo (JP)

(21) Appl. No.: 18/289,977

(22) PCT Filed: May 19, 2022
(86) PCT No.: PCT/JP2022/020788

§ 371 Date: May 16, 2024

(30) Foreign Application Priority Data
May 24, 2021 (JP) 2021-086740

(51) Int. Cl. C08G 59/66; C08G 59/68; C08G 65/326; C08K 5/19; C08K 5/50; C09J 11/06; C09J 163/00

(52) U.S. Cl. CPC C08G 59/66; C08G 59/686; C08G 65/326; C09J 11/06; C09J 163/00; C08K 5/19; C08K 5/50

(57) ABSTRACT

A polymer composition contains a polyether polymer having a thiol group, in which the polyether polymer having a thiol group has a polyether moiety represented by Formula (1) in a main chain and a structural unit represented by Formula (2) at a terminal, a thiol group content in the polyether polymer containing a thiol group is 8 wt/mass % or more, and the polymer composition further contains a cationic surfactant

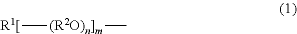

where R¹ is a residue obtained by removing a hydrogen atom from a polyvalent amine or polyhydric alcohol having 10 or less carbon atoms, R² is an alkylene group having 2 to 6 carbon atoms, n is 1 to 200, and m is 2 to 8.

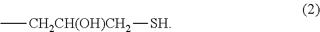

### TECHNICAL FIELD

This disclosure relates to an epoxy resin composition, a curing agent for an epoxy resin, and a fast curing adhesive.

### BACKGROUND

A cured product containing an epoxy resin has good adhesiveness, chemical resistance, a low shrinkage rate, and excellent physical properties and has been widely used conventionally as a coating material, an adhesive and the like.

Among them, epoxy adhesives have good adhesiveness and chemical resistance. As a curing agent for an epoxy adhesive, a polythiol compound is used when fast curability and high adhesive strength are required. When a polythiol compound is used as a curing agent for an epoxy adhesive, curing is rapid as compared with other epoxy curing agents.

Many terminal-thiol-group-containing compounds having no polysulfide skeleton in the main chain have been reported as compounds capable of causing a thiol group and an epoxy group to rapidly react (see, for example, Japanese Patent Laid-open Publication No. 8-269203). Among them, as an economical and safe curing agent for an epoxy resin, a compound having a polyether skeleton in the main chain and having three or more thiol groups in one molecule is widely commercially available. Examples of the compound having a polyether skeleton in the main chain and three or more thiol groups in one molecule include “POLYTHIOL QE-340M” manufactured by Toray Fine Chemicals Co., Ltd. and “Capcure 3-800” manufactured by Gabriel Performance Products, LLC. Generally, such a polymercaptan-based curing agent is used in a state of being mixed with an epoxy resin and a tertiary amine as a curing accelerator.

An epoxy adhesive using a compound having a polyether skeleton in the main chain and three or more thiol groups in one molecule as a polymercaptan-based curing agent cures at normal temperature for a curing time of about 2 to 10 minutes. An epoxy adhesive using a compound having a polyether skeleton in the main chain and three or more thiol groups in one molecule as a polymercaptan-based curing agent has a problem that curing is fast at room temperature, but it is difficult to cure at a relatively low temperature of 15° C. or lower, that is, curing is slow in winter or cold environments.

Therefore, an epoxy adhesive having a sufficiently high curing rate even in a low temperature environment has been demanded.

It could therefore be helpful to provide a polymer composition that can be used as a curing agent for an epoxy resin having a high curing rate even in a low temperature environment and having a low viscosity and good stability and adhesiveness.

It could also be helpful to provide an epoxy-resin-containing composition as a curing agent for an epoxy resin having a high curing rate even in a low temperature environment and having a low viscosity and good stability and adhesiveness.

### SUMMARY

We thus provide a polymer composition containing a polyether polymer having a thiol group, in which the polyether polymer having a thiol group has a polyether moiety represented by Formula (1) in a main chain and a structural unit represented by Formula (2) at a terminal, a thiol group content in the polyether polymer having a thiol group is 8 mass % or more, and the polymer composition further contains a cationic surfactant

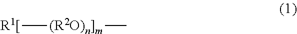

where R¹ is a residue obtained by removing a hydrogen atom from a polyvalent amine or polyhydric alcohol having 10 or less carbon atoms, R² is an alkylene group having 2 to 6 carbon atoms, n is 1 to 200, and m is 2 to 8.

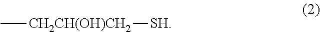

We also provide an epoxy resin composition containing the polymer composition and an epoxy resin, in which the content of the epoxy resin is 100 to 600 parts by mass with respect to 100 parts by mass of the polyether polymer having a thiol group.

We further provide a curing agent for an epoxy resin containing the polymer composition.

We still further provide a fast curing adhesive containing the polymer composition, an epoxy resin, and an amine.

Our polymer compositions can be used as a curing agent for an epoxy resin having a high curing rate even in a low temperature environment and having a low viscosity and good stability and adhesiveness.

The epoxy resin compositions have a high curing rate even in a low temperature environment and a low viscosity and good stability and adhesiveness.

### DETAILED DESCRIPTION

### Polyether Polymer Having Thiol Group

Our polymer compositions contain a polyether polymer having a thiol group.

The polyether polymer having a thiol group has a polyether moiety represented by Formula (1) in the main chain

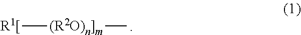

R¹ is a residue obtained by removing m hydrogen atoms from a polyvalent amine or polyhydric alcohol having 10 or less carbon atoms.

Examples of the polyvalent amine or polyhydric alcohol having 10 or less carbon atoms include glycerin, trimethylolpropane, trimethylolethane, hexanetriol, diglycerin, pentaerythritol, triethanolamine, ethylenediamine, and sucrose. These polyvalent amines and polyhydric alcohols may be used alone or in combination. Among the polyols described above, glycerin, trimethylolpropane, and trimethylolethane are particularly preferable.

R² is an alkylene group having two to six carbon atoms. Examples of the alkylene group having two to six carbon atoms include ethylene, n-propylene, isopropylene, n-butylene, and isobutylene.

n is 1 to 200, preferably 1 to 100. m is 2 to 8, preferably 2 to 5.

The polyether polymer having a thiol group has a structural unit represented by Formula (2) at a terminal

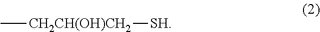

The structural unit represented by Formula (2) can be preferably obtained by reacting a halogen-terminated polyether polymer obtained by adding epihalohydrin with alkali hydrosulfide and/or alkali polysulfide in a polar solvent.

The halogen-terminated polyether polymer is obtained by adding epihalohydrin (b) to a polyol (a) having a polyether moiety in the main chain and having two or more hydroxy groups at the terminal.

To synthesize the polyether polymer having a thiol group, the polyol (a) has a chemical structure represented by Formula (3)

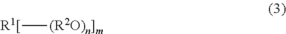

where R¹ is a residue obtained by removing m hydrogen atoms from a polyvalent amine or polyhydric alcohol having 10 or less carbon atoms, R² is an alkylene group having 2 to 4 carbon atoms, n is 1 to 200, and m is 2 to 8.

Examples of the polyol (a) include a polyvalent amine or a polyhydric alcohol to which ethylene oxide, propylene oxide, tetrahydrofuran or the like is added. Examples of the polyvalent amine or polyhydric alcohol include glycerin, trimethylolpropane, trimethylolethane, hexanetriol, triethanolamine, diglycerin, pentaerythritol, ethylenediamine, and sucrose. These polyvalent amines and polyhydric alcohols may be used alone or in combination. Among the polyols described above, polypropylene glycol obtained by adding propylene oxide to glycerin, trimethylolpropane, or trimethylolethane is particularly preferable.

The polyol (a) preferably has a molecular weight of 200 to 10,000, more preferably 200 to 3,000.

The polyether polymer having a thiol group has a thiol group content of 8 mass % or more, preferably 8 to 16 mass %, more preferably 9 to 16 mass %.

The viscosity of the polyether polymer having a thiol group is preferably 9 to 17 Pas, more preferably 12 to 14 Pa·s, from the viewpoint of handleability.

### Cationic Surfactant

Our polymer compositions further contain a cationic surfactant. By containing a cationic surfactant, the reaction is accelerated, and fast curability can be exhibited even in a low temperature environment.

The cationic surfactant (B) is preferably a quaternary ammonium salt or a quaternary phosphonium salt.

Preferable examples of the quaternary ammonium salt include tetrabutylammonium fluoride, benzyltributylammonium chloride, benzyltriethylammonium chloride, benzyltrimethylammonium chloride, tetra-n-butylammonium chloride, tetraethylammonium chloride, methyltributylammonium chloride, benzyltri-n-butylammonium bromide, benzyltriethylammonium bromide, benzyltrimethylammonium bromide, n-octyltrimethylammonium bromide, hexyltrimethylammonium bromide, tetrabutylammonium bromide, tetraethylammonium bromide, tetradecyltrimethylammonium bromide, tetra-n-propylammonium bromide, tetraoctylammonium bromide, tetrabutylammonium iodide, tetraethylammonium iodide, tetra-n-propylammonium iodide, trimethylphenylammonium iodide, tetrabutylammonium hydrogen sulfate, benzyltrimethylammonium hydroxide, phenyltrimethylammonium hydroxide, tetrabutylammonium hydroxide, tetraethylammonium hydroxide, tetrapropylammonium hydroxide, tetrabutylammonium hydrogen sulfate, and tetrabutylammonium tetrafluoroborate.

Preferable examples of the quaternary phosphonium salt include tetrabutylphosphonium fluoride, benzyltributylphosphonium chloride, benzyltriethylphosphonium chloride, benzyltrimethylphosphonium chloride, tetra-n-butylphosphonium chloride, tetraethylphosphonium chloride, methyltributylphosphonium chloride, benzyltri-n-butylphosphonium bromide, benzyltriethylphosphonium bromide, benzyltrimethylphosphonium bromide, n-octyltrimethylphosphonium bromide, hexyltrimethylphosphonium bromide, tetrabutylphosphonium bromide, tetraethylphosphonium bromide, tetradecyltrimethylphosphonium bromide, tetra-n-propylphosphonium bromide, tetraoctylphosphonium bromide, tetrabutylphosphonium iodide, tetraethylphosphonium iodide, tetra-n-propylphosphonium iodide, trimethylphenylphosphonium iodide, tetrabutylphosphonium hydrogen sulfate, benzyltrimethylphosphonium hydroxide, phenyltrimethylphosphonium hydroxide, tetrabutylphosphonium hydroxide, tetraethylphosphonium hydroxide, tetrapropylphosphonium hydroxide, tetrabutylphosphonium hydrogen sulfate, and tetrabutylphosphonium tetrafluoroborate.

The cationic surfactant is more preferably tetraethylammonium bromide, tetrabutylammonium bromide, tetrabutylammonium iodide, tetrabutylammonium hydrogen sulfate, tetrabutylphosphonium bromide, tetraoctylammonium bromide, benzyltriethylammonium chloride, or methyltributylammonium chloride.

The cationic surfactant is still more preferably tetrabutylammonium bromide, tetrabutylammonium hydrogen sulfate, tetrabutylphosphonium bromide, tetraoctylammonium bromide, benzyltriethylammonium chloride, or methyltributylammonium chloride.

The cationic surfactants may be used alone or may be used in combination of two or more thereof.

The content of the cationic surfactant in the polymer composition is preferably 0.01 to 5.0 mass %. By setting the content to 0.01 mass % or more, more preferably 0.05 mass % or more, still more preferably 0.10 mass % or more, the curing rate can be effectively increased. In addition, setting the content to 5.0 mass % or less, more preferably 3.0 mass % or less, still more preferably 1.0 mass % or less is advantageous in terms of cost.

The cationic surfactant can be blended at any timing. The addition may be performed directly to the polyether polymer having a thiol group or performed in a post-treatment step after the reaction by which the polyether polymer having a thiol group is synthesized. In addition, the addition may be performed at the stage of the reaction for synthesizing the polyether polymer having a thiol group. Regardless of the timing of blending, the same effect can be obtained as long as the composition contains the component of the cationic surfactant.

The polyether polymer having a thiol group and the cationic surfactant may be dissolved in a solvent. Such an aspect improves the coatability of the polymer composition.

As the solvent, an alcohol-based solvent is preferably used. From the viewpoint that the solvent can be distilled off by slight heating after the polymer composition is applied to a substrate or the like, an alcohol having a low boiling point is preferable, and particularly, for example, methanol, ethanol, isopropanol, n-butanol, t-butanol, n-heptanol, n-hexanol or the like is preferable because it is excellent in compatibility with the polyether polymer having a thiol group and the cationic surfactant. Among them, methanol and ethanol, which have low molecular weights, are more preferable.

### Curing Agent for Epoxy Resin

Our polymer composition is suitably used as a curing agent for an epoxy resin. That is, the curing agent for an epoxy resin contains the polymer composition.

### Epoxy Resin Composition

The epoxy resin composition contains the polymer composition and an epoxy resin.

Examples of the epoxy resin include an epoxy resin obtained by adding epichlorohydrin to a polyhydric phenol such as bisphenol A, bisphenol F, resorcinol, hydroquinone, pyrocatechol, 4,4-dihydroxybiphenyl, and 1,5-hydroxynaphthalene, an epoxy resin obtained by adding epichlorohydrin to a polyhydric alcohol such as ethylene glycol, propylene glycol, and glycerin, an epoxy resin obtained by adding epichlorohydrin to an aromatic dicarboxylic acid such as oxybenzoic acid and phthalic acid, and a polysulfide polymer having an epoxy group at the terminal (trade names “FLEP-50” and “FLEP-60,” both manufactured by Toray Fine Chemicals Co., Ltd.).

The epoxy resin is preferably liquid at normal temperature.

The epoxy resin content in the epoxy resin composition is preferably 80 to 600 parts by mass with respect to 100 parts by mass of the polyether polymer having a thiol group. The content is more preferably 100 to 400 parts by mass, still more preferably 120 to 200 parts by mass.

The epoxy resin composition preferably contains an amine.

The content of the amine in the epoxy resin composition is preferably 1 to 100 parts by mass with respect to 100 parts by mass of the epoxy resin. When the content is 1 part by mass or more, curing can be effectively accelerated. In addition, setting the content to 100 parts by mass or less, more preferably 80 parts by mass or less, still more preferably 60 parts by mass or less is advantageous in terms of cost.

The amine may be those publicly known as usual curing agents for epoxy resins and catalysts, and examples thereof include aliphatic diamines such as ethylenediamine, diethylenetriamine, triethylenetetramine, pentaethylenehexamine, trimethylenediamine, hexamethylenediamine, and tetramethylenediamine, aliphatic tertiary amines such as N,N-dimethylpropylamine and N,N,N′,N′-tetramethylhexamethylenediamine, alicyclic tertiary amines such as N-methylpiperidine and N,N′-dimethylpiperazine, aromatic tertiary amines such as benzyldimethylamine, dimethylaminomethylphenol, and 2,4,6-tris(dimethylaminomethyl) phenol, polyamine epoxy resin adducts produced by reacting an epoxy resin with an excess of amine, polyamine-ethylene oxide adducts, polyamine-propylene oxide adducts, cyanoethylated polyamines, diamines whose main chain is silicon, dehydration condensates obtained by reacting polyamines with phenols, aldehydes and the like, imidazoles such as 2-ethyl-4-methylimidazole, and modified polyamines.

As the modified polyamine using an amine as a raw material, a modified product of diethylenetriamine, a modified product of triethylenetetramine, a modified product of tetraethylenepentamine and the like are particularly preferable and among them, for example, a modified product obtained by reacting a mono- or polyepoxy compound with an amino group of triethylenetetramine is more preferable. Examples thereof include “BB-AMINE 3138” manufactured by BB RESINS SRL.

The amine preferably has an amine value of 900 to 1,400, more preferably 1,000 to 1,300, still more preferably 1,100 to 1,200.

When the amine is a modified polyamine, the amine value is preferably 1,000 to 1,300, more preferably 1,100 to 1,200.

The amine value is defined as the number of milligrams of potassium hydroxide equivalent to perchloric acid required to neutralize the total basic nitrogen contained in 1 g of the amine.

The epoxy resin composition preferably has a curing time at 5° C. of 15 minutes or less. The curing time of the epoxy-resin-containing composition is defined as the gel time until a toothpick (made of wood, 2 mm in diameter×150 mm in length) put in the epoxy resin composition stands still. The other measurement conditions are based on the method of determining the pot life of multi-component adhesives described in JIS K 6870:2008.

### Curing Agent for Epoxy Resin

The curing agent for an epoxy resin contains the polymer composition.

### Fast Curing Adhesive

A fast curing adhesive contains the polymer composition, an epoxy resin, and an amine.

As the amine in the fast curing adhesive, amines of the same preferable modes as those in the epoxy resin composition can be employed.

That is, for example, the amine value of the amine in the fast curing adhesive is preferably 1,000 to 1,300.

The fast curing adhesive preferably has a curing time at 5° C. of 7 minutes or less.

The fast curing adhesive preferably has an onset time of adhesion of 12 minutes or less to a steel plate cold commercial at 8° C.

### EXAMPLES

Our compositions, agents and adhesives will be specifically described by Examples and Comparative Examples. In the following examples, a general reagent purchased from a reagent manufacturer was used as a raw material unless otherwise specified. The following apparatus and method were used for the analysis.

### Measurement Methods

### (1) Viscosity

The viscosity of a sample at 25° C. was measured using a viscometer (U-EII manufactured by Toki Sangyo Co., Ltd.).

### (2) Mercaptan Content

A sample was dissolved in a mixed solution of toluene and pyridine, an aqueous potassium iodide solution was added, and then titration was performed using an iodine standard solution to measure the mercaptan content.

### (3) Content of Cationic Surfactant

The content of the cationic surfactant was determined by dissolving the polymer composition in an alcohol solvent, then performing extraction with an extraction solvent, and analyzing the extract phase by ion chromatography.

More specifically, 0.1 g to 1.0 g of the polymer composition was dissolved in 20 ml of n-hexanol, and then 15 ml of a 2.5-mM aqueous nitric acid solution was added. After the components were well mixed, the mixture was separated, and the aqueous phase side was analyzed by ion chromatography in which the following conditions were satisfied. The concentration of the resulting aqueous phase was corrected by the partition ratio to calculate the content of the cationic surfactant in the polymer composition.

### Ion Chromatography Analysis Conditions

Column: “Shodex” IC YK-421

Mobile phase: 2.5-mM aqueous nitric acid solution/acetonitrile (volume ratio: 8/2)

Flow rate: 1.0 ml/min

Temperature: 40° C.

Detector: electrical conductivity detector.

### (4) Curing Time at 5° C.

An epoxy resin composition was obtained by mixing 8.0 g of a polymer composition of one of examples and comparative examples, 10.0 g of a bisphenol A type epoxy resin (“jER 828” manufactured by Mitsubishi Chemical Corporation) having an epoxy equivalent of 184 to 194 as the epoxy resin, and 1.0 g of “BB-AMINE 3138” manufactured by BB RESINS SRL having an amine value of 1,150 as the amine.

The gel time until a toothpick (made of wood, 2 mm in diameter×150 mm in length) put in the epoxy resin composition stood still was regarded as the curing time. Specifically, under the condition of 5° C., the toothpick was put in the epoxy resin composition obtained by mixing the raw materials according to each example, and the point at which the toothpick stopped moving was defined as gel time. The gel time was measured from the start of pre-mixing and also includes defoaming mixing time. The other measurement conditions were based on the method of determining the pot life of multi-component adhesives described in JIS K 6870:2008. (5) Onset Time of Adhesion at 8° C.

Two steel sheets were actually bonded together under a low temperature environment, and the onset time of adhesion at a low temperature was measured. Specifically, under an environment of 8° C., the epoxy resin composition was applied to a 25 mm square of a 1.6 mm thick×25 mm wide×100 mm long steel plate cold commercial (SPCC-SD (general use, standard temper, dull finish) specified in JIS G 3141:2017), and another steel plate cold commercial having the same size was bonded. The time until the two steel plate cold commercials adhered and stopped moving was taken as the onset time of adhesion. Synthesis Examples

### Polyether Polymer 1 Having Thiol Group

In a 3-L reaction vessel, 500 g of a trifunctional polypropylene glycol (OH value: 510 mg KOH/polypropylene glycol) obtained by adding propylene oxide to glycerin and 3.0 g of stannic chloride pentahydrate were charged, the temperature was raised to 50° C., 496 g of epichlorohydrin was added dropwise over 1 hour, and the mixture was then stirred at 80° C. for 2 hours. To the obtained halogen-terminated polyether polymer, 1,227 g of N,N-dimethylformamide was added and mixed. Thereafter, 634 g of sodium hydrosulfide (concentration: 48%) was added thereto, and nitrogen purging was performed. Thereafter, the mixture was stirred at 80° C. for 2 hours. Thereafter, the salt and N,N-dimethylformamide were removed to provide a colorless and transparent liquid polyether polymer 1 having a thiol group.

The polyether polymer 1 having a thiol group had a mercaptan content of 13.0 mass % and a viscosity at 25° C. of 13.6 Pa·s.

### Polyether Polymer 2 Having Thiol Group

In a 3-L reaction vessel, 500 g of a trifunctional polypropylene glycol (OH value: 400 mg KOH/polypropylene glycol) obtained by adding propylene oxide to trimethylolpropane and 3.7 g of a 50% aqueous stannic chloride solution were charged, the temperature was raised to 50° C., 462 g of epichlorohydrin was added dropwise over 1 hour, and the mixture was then stirred at 80° C. for 2 hours. To the obtained halogen-terminated polyether polymer, 1,227 g of N,N-dimethylformamide was added and mixed. Thereafter, 589 g of sodium hydrosulfide (concentration: 48%) was added thereto. Thereafter, the mixture was stirred at 80° C. for 2 hours. Thereafter, the salt and N,N-dimethylformamide were removed to provide a colorless and transparent liquid polyether polymer 2 having a thiol group.

The polyether polymer 2 having a thiol group had a mercaptan content of 11.4 mass % and a viscosity at 25° C. of 10.2 Pa·s.

### Example 1

To 100 g of the polyether polymer 1 having a thiol group, 0.42 g of tetraethylammonium bromide was weighed and mixed under conditions of 80° C. and 1 hour to provide a polymer composition.

The content of tetraethylammonium bromide in the polymer composition was 0.4 mass %. The curing time of the polymer composition at 5° C. was 6.8 minutes.

### Example 2

A polymer composition was obtained in the same manner as in Example 1 except that tetraethylammonium bromide was changed to 0.64 g of tetrabutylammonium bromide.

The content of tetrabutylammonium bromide in the polymer composition was 0.6 mass %. The curing time of the polymer composition at 5° C. was 5.9 minutes. The onset time of adhesion of the polymer composition at 8° C. was 11.7 minutes.

### Example 3

A polymer composition was obtained in the same manner as in Example 1 except that tetraethylammonium bromide was changed to 0.74 g of tetrabutylammonium iodide.

The content of tetrabutylammonium iodide in the polymer composition was 0.7 mass %. The curing time of the polymer composition at 5° C. was 6.2 minutes.

### Example 4

A polymer composition was obtained in the same manner as in Example 1 except that tetraethylammonium bromide was changed to 0.68 g of tetrabutylammonium sulfate.

The content of tetrabutylammonium hydrogen sulfate in the polymer composition was 0.7 mass %. The curing time of the polymer composition at 5° C. was 5.5 minutes.

### Example 5

A polymer composition was obtained in the same manner as in Example 1 except that tetraethylammonium bromide was changed to 0.68 g of tetrabutylphosphonium bromide.

The content of tetrabutylammonium hydrogen sulfate in the polymer composition was 0.7 mass %. The curing time of the polymer composition at 5° C. was 6.0 minutes. The onset time of adhesion of the polymer composition at 8° C. was 11.4 minutes.

### Example 6

A polymer composition was obtained in the same manner as in Example 1 except that tetraethylammonium bromide was changed to 0.46 g of benzyltriethylammonium chloride.

The content of benzyltriethylammonium chloride in the polymer composition was 0.5 mass %. The curing time of the polymer composition at 5° C. was 5.3 minutes. The onset time of adhesion of the polymer composition at 8° C. was 10.9 minutes.

### Example 7

A polymer composition was obtained in the same manner as in Example 1 except that tetraethylammonium bromide was changed to 0.47 of tributylmethylammonium chloride.

The content of tributylmethylammonium chloride in the polymer composition was 0.5 mass %. The curing time of the polymer composition at 5° C. was 6.0 minutes.

### Comparative Example 1

The polyether polymer 1 having a thiol group was used as a polymer composition as it was without adding anything.

No cationic surfactant was detected from the polymer composition. The curing time of the polymer composition at 5° C. was 8.1 minutes. The onset time of adhesion of the polymer composition at 8° C. was 16.2 minutes.

### Comparative Example 2

The polyether polymer 2 having a thiol group was used as a polymer composition as it was without adding anything.

No cationic surfactant was detected from the polymer composition.

The curing time of the polymer composition at 5° C. was 17.3 minutes. The onset time of adhesion of the polymer composition at a low temperature of 8° C. was 29.0 minutes.

### Comparative Example 3

A commercially available polyether polymer having a thiol group with the trade name “Capcure 3-800” was used as a polymer composition as it was without adding anything.

No cationic surfactant was detected from the polymer composition. The curing time of the polymer composition at 5° C. was 14.0 minutes. The onset time of adhesion of the polymer composition at 8° C. was 24.0 minutes.

TABLE 1

| | Cationic surfactant | | Curing time |
|---|---|---|---|
| | | Content in polymer | at 5° C. |
| | Type | composition (mass %) | (min) |
| Example 1 | Tetraethylammonium bromide | 0.4 | 6.8 |
| Example 2 | Tetrabutylammonium bromide | 0.6 | 5.9 |
| Example 3 | Tetrabutylammonium iodide | 0.7 | 6.2 |
| Example 4 | Tetrabutylammonium hydrogen sulfate | 0.7 | 5.5 |
| Example 5 | Tetrabutylphosphonium bromide | 0.7 | 6.0 |
| Example 6 | Benzyltriethylammonium chloride | 0.5 | 6.4 |
| Example 7 | Tributylmethylammonium chloride | 0.5 | 6.0 |
| Comparative Example 1 | Absent | — | 8.1 |
| Comparative Example 2 | Absent | — | 17.3 |
| Comparative Example 3 | Absent | — | 14.0 |

Table 1 summarizes the curing times at 5° C. in Examples 1 to 7 and Comparative Examples 1 to 3. An epoxy resin composition using the polymer composition of any of Examples 1 to 7 had a curing time at 5° C. of 7 minutes or less.

TABLE 2

| | | Onset Time of | Curing time |
|---|---|---|---|
| | | Adhesion at 8° C. | at 5° C. |
| | Type of cationic surfactant | (min) | (min) |
| Example 2 | Tetrabutylammonium bromide | 11.7 | 5.9 |
| Example 5 | Tetrabutylphosphonium bromide | 11.4 | 6.0 |
| Example 6 | Benzyltriethylammonium chloride | 10.9 | 6.4 |
| Comparative Example 1 | Absent | 16.2 | 8.1 |
| Comparative Example 2 | Absent | 29.0 | 17.3 |
| Comparative Example 3 | Absent | 24.0 | 14.0 |

Table 2 summarizes the onset times of adhesion at 8° C. and the curing times at 5° C. in Examples 2, 5, and 6 and Comparative Examples 1 to 3. An epoxy resin composition using the polymer composition of any of Examples 2, 5, and 6 had an onset time of adhesion at 8° C. of 12 minutes or less. As shown in Table 2, we found that there was an interphase relationship between the onset time of adhesion at 8° C. and the curing time at 5° C. and that an epoxy resin composition having a short curing time at 5° C. quickly showed an adhesive force to a steel plate cold commercial at a low temperature of 8° C.

1-14. (canceled)

15. A polymer composition comprising a polyether polymer having a thiol group,
wherein the polyether polymer having a thiol group has a polyether moiety represented by Formula (1) in a main chain and a structural unit represented by Formula (2) at a terminal,
a thiol group content in the polyether polymer having a thiol group is 8 mass % or more, and
the polymer composition further contains a cationic surfactant: 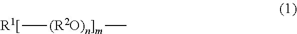
where R¹ is a residue obtained by removing a hydrogen atom from a polyvalent amine or polyhydric alcohol having 10 or less carbon atoms, R² is an alkylene group having 2 to 6 carbon atoms, n is 1 to 200, and m is 2 to 8, and

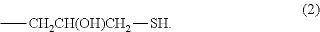

16. The polymer composition according to claim 15, wherein the polyether polymer having a thiol group has an SH content of 8 to 16 mass %.

17. The polymer composition according to claim 15, wherein the cationic surfactant is a quaternary ammonium salt or a quaternary phosphonium salt.

18. The polymer composition according to claim 15, wherein a content of the cationic surfactant is 0.01 to 5.0 mass %.

19. An epoxy resin composition comprising:
the polymer composition according to claim 15; and
an epoxy resin,
wherein a content of the epoxy resin is 100 to 600 parts by mass with respect to 100 parts by mass of the polyether polymer having a thiol group.

20. The epoxy resin composition according to claim 19, further comprising 1 to 60 parts by mass of an amine with respect to 100 parts by mass of the epoxy resin.

21. The epoxy resin composition according to claim 20, wherein the amine is a modified product of an amine having three or more amino groups in one molecule.

22. The epoxy resin composition according to claim 20, wherein the amine has an amine value of 1,000 to 1,300.

23. The epoxy resin composition according to claim 20, wherein a curing time at 5° C. is 7 minutes or less.

24. A curing agent for an epoxy resin, comprising the polymer composition according to claim 15.

25. A fast curing adhesive comprising:
the polymer composition according to claim 15;
an epoxy resin; and
an amine.

26. The fast curing adhesive according to claim 25, having a curing time at 5° C. of 7 minutes or less.

27. The fast curing adhesive according to claim 25, having an onset time of adhesion of 12 minutes or less to a steel plate cold commercial at 8° C.

28. The fast curing adhesive according to claim 25, wherein the amine has an amine value of 1,000 to 1,300.
